(19) United States
(12) Patent Application Publication
(10) Pub. No.: US 2004/0032578 A1
(43) Pub. Date: Feb. 19, 2004

(54) Hinge device for copier lid

(76) Inventor: Hung-Chieh Chen, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/216,905

(22) Filed: Aug. 13, 2002

(51) Int. Cl. G03B 27/62

(52) U.S. Cl. 355/75; 355/40; 358/474

(57) ABSTRACT

A hinge device for copier lid is provided. The hinge device includes a connecting rod mechanism having a first connecting rod, a second connecting rod, a third connecting rod, and a base, and the first connecting rod is connected with the second connecting rod by a first pivot pin, and the second connecting rod is connected with the third connecting rod by a second pivot pin, and the base is connected with the third connecting rod by a third pivot pin, and the first connecting rod is connected with the base by a fourth pivot pin; and a flexible device connected to the first connecting rod and penetratably connected by the first pivot pin, and the flexible device abutting upon the second connecting rod to transfer spring force of the flexible device from the second connecting rod to the base, thereby rendering the copier lid close, open or static.

### BACKGROUND OF THE INVENTION

1. Field of the Invention

The present invention relates to a hinge device for copier lid. The hinge device is capable of urging the copier lid to open or close in a more laborsaving way. Further, the copier lid can be adjusted at multi-stage stationary angles in combination with the hinge device according to the present invention.

2. Description of the Prior Art

Hinge devices are widely used in some applications such as photocopiers, scanners or the like. In use, the hinge device typically connected to a document-pressing lid facilitates the close or open of the lid for a user.

FIG. 1 illustrates a prior art hinge device for a copier lid. The hinge device encompasses an outer sleeve 1a, compression-type spring 2a, sliding sleeve 3a, top pin 4a, and base 5a. The base 5a comprises an upper wheel portion 6a. A lower vertical rod 7a is connected to the bottom of the base 6a. The compression-type spring 2a and sliding sleeve 3a are installed in the outer sleeve 1a. As illustrated, when assembly, the outer sleeve 1a and the sliding sleeve 3a together restrain the compression-type spring 2a therein. The outer sleeve 1a is pivotally connected to the base 5a. The sliding sleeve 3a is buckled with the top pin 4a that leans against the curved peripheral side of the upper wheel portion 6a of the base 5a. A lid 9 connected with the outer sleeve 1a can move along the path defined by the curved peripheral side of the upper wheel portion 6a of the base 5a.

The prior art hinge device urges the lid 9 to open or close by capitalizing on the spring force provided by the compression-type spring 2a that forces the top pin 4a to tightly lean against the upper wheel portion 6a of the base 5a. However, the prior art hinge device has some shortcomings summarized as follows.

1. Since the prior art hinge device functions according to the interaction between the sliding sleeve 3a, compression-type spring 2a, and upper wheel portion 6a, it is not easy to precisely control the open position of the lid 9. Further, the cost of manufacturing the upper wheel portion 6a is high.

2. The path and movement range of the lid 9 fixed on the outer sleeve 1a are restricted by the curved peripheral side of the upper wheel portion 6a of the base 5a. The flexibility of adjusting the rotation path and movement range of the lid is relatively low.

3. The prior art hinge device occupies more space since it needs a compression-type spring 2a with a large spring constant and the upper wheel portion 6a that defines the movement path.

4. The prior art hinge device urges the lid 9 to open or close by capitalizing on the spring force provided by the compression-type spring 2a that forces the top pin 4a to tightly lean against the upper wheel portion 6a of the base 5a. Friction loss occurred between two components of the prior art hinge device reduces the lifetime of such device.

Accordingly, there is a strong need for an improved hinge device which is inexpensive and have good reliability.

### SUMMARY OF THE INVENTION

The primary objective of the invention is to provide an improved hinge device to solve the above-mentioned problems. The structure of the hinge device is simplified so that the movement of the lid is more precise. Further, the device of this invention can reduce friction loss typically occurred between components of prior art hinge device.

Another objective of the present invention is to provide a hinge device for copier lid that is easy to assembly.

Still another objective of the present invention is to provide a hinge device for copier lid that occupies small space.

Still another objective of the present invention is to provide a hinge device for copier lid that is capable of adjusting stationary angle of the lid by adjusting an adjusting screw and the friction force thereof.

Still another objective of the present invention is to provide a hinge device for copier lid that is easy to substitute components therein. By changing the length of the connecting rods, the open force or close force needed to be exerted on the lid and the stationary angle and pressing force can be adjusted.

In accordance with the present invention, a hinge device for copier lid is provided. The hinge device includes a connecting rod mechanism comprising a first connecting rod, a second connecting rod, a third connecting rod, and base, the first connecting rod is connected with the second connecting rod by first pivot pin, the second connecting rod is connected with the third connecting rod by second pivot pin, the base is connected with the third connecting rod by third pivot pin, the first connecting rod is connected with the base by fourth pivot pin; and a flexible device connected to the first connecting rod and passed by the first pivot pin, and the flexible device abutting upon the second connecting rod to transfer spring force of the flexible device from the second connecting rod to the base, thereby rendering the copier lid close, open or static.

Other objects, advantages and novel features of the invention will become more clearly and readily apparent from the following detailed description when taken in conjunction with the accompanying drawings.

### BRIEF DESCRIPTION OF THE DRAWINGS

FIG. 1 illustrates a cross-sectional view of a prior art hinge device assembled on a copier machine.

FIG. 2 is a side view showing this invention.

FIG. 3 is a perspective view of this invention.

FIG. 4 is a perspective view of this invention, when combined with a copier lid and copier machine, according to this invention.

FIG. 5 is an exploded diagram of this invention.

FIG. 6 is a side view showing an initial state when the lid starts to open according to this invention.

FIG. 7 is a side view showing an initial state when the lid opens to an equilibrium position according to this invention.

FIG. 8 is a side view showing an initial state when the lid starts to close according to this invention.

FIG. 9 is a side view showing an initial state when the lid is closed according to this invention.

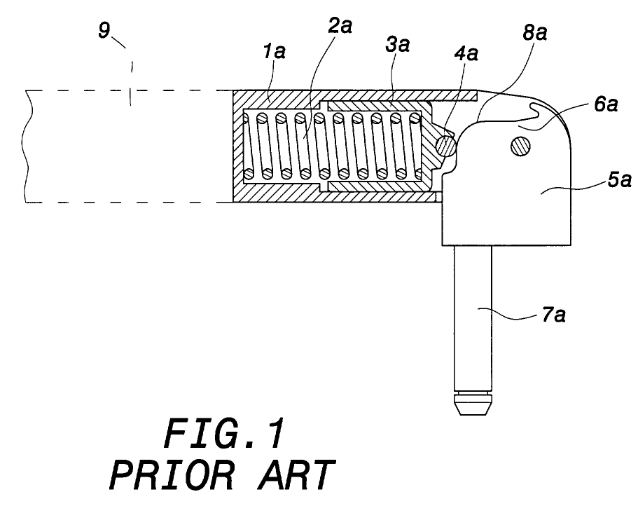

### DETAILED DESCRIPTION OF THE PREFERRED EMBODIMENT

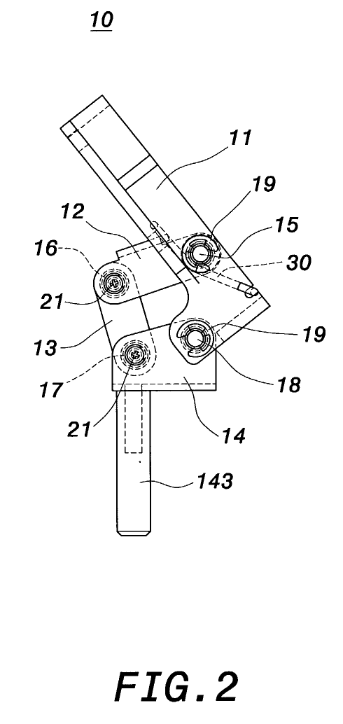

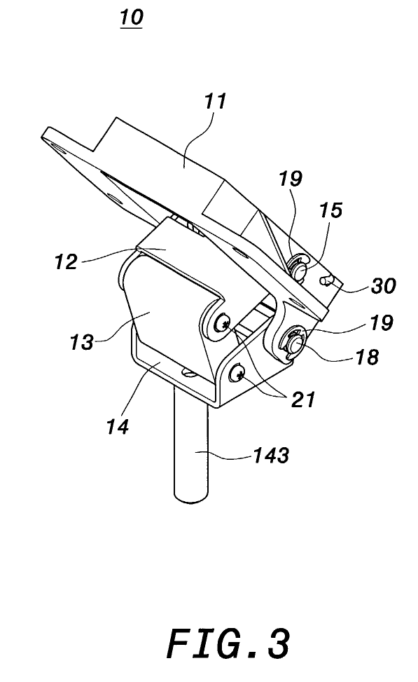

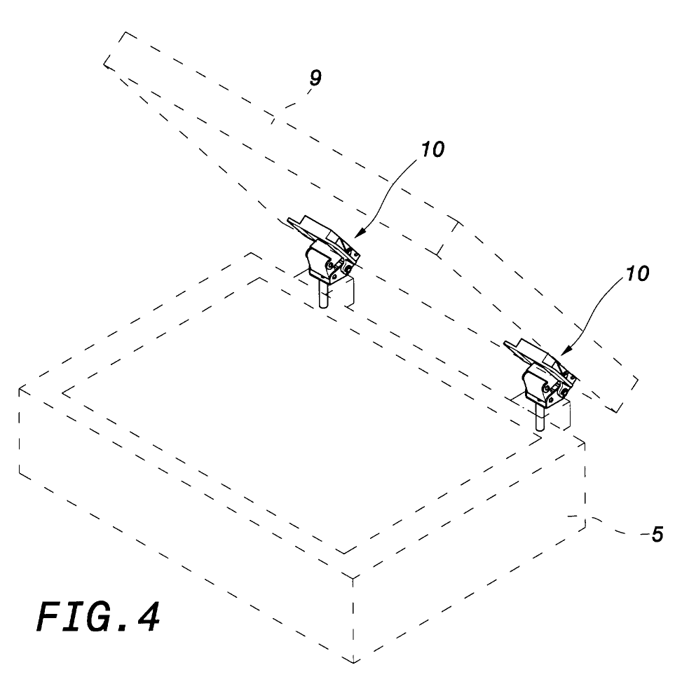

Please refer to FIG. 2 and FIG. 3. The present invention is directed to an improved hinge device particularly for copier lid. The hinge device of this invention comprises a connecting rod mechanism 10 and spring 30. Also referring to FIG. 4, the spring 30 and a copier lid 9 are combined with the connecting rod mechanism 10. After assembling the lid 9 and the connecting rod mechanism 10, the combination is installed on the copier machine 5 by inserting vertical rods into the associated holes on the copier machine 5.

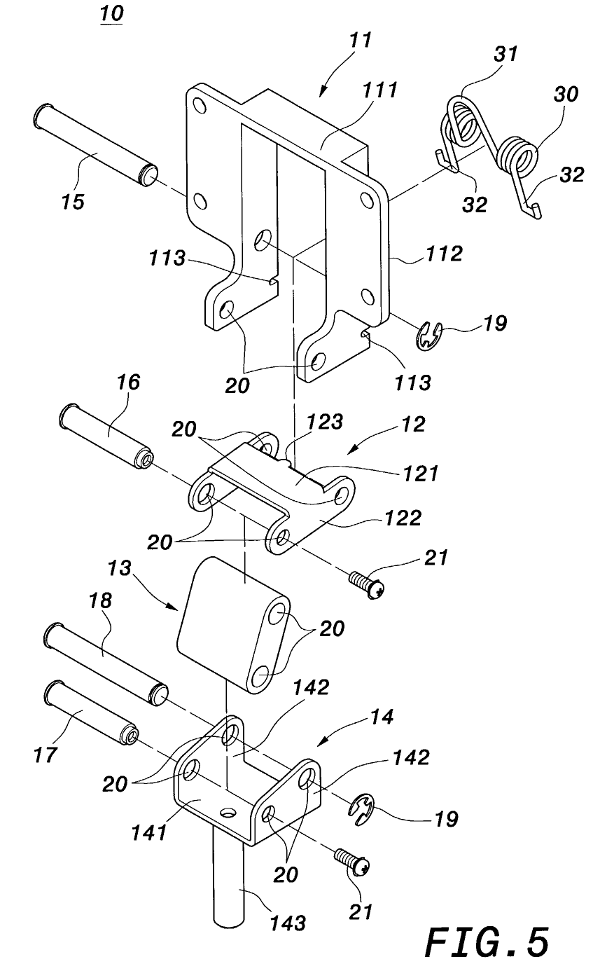

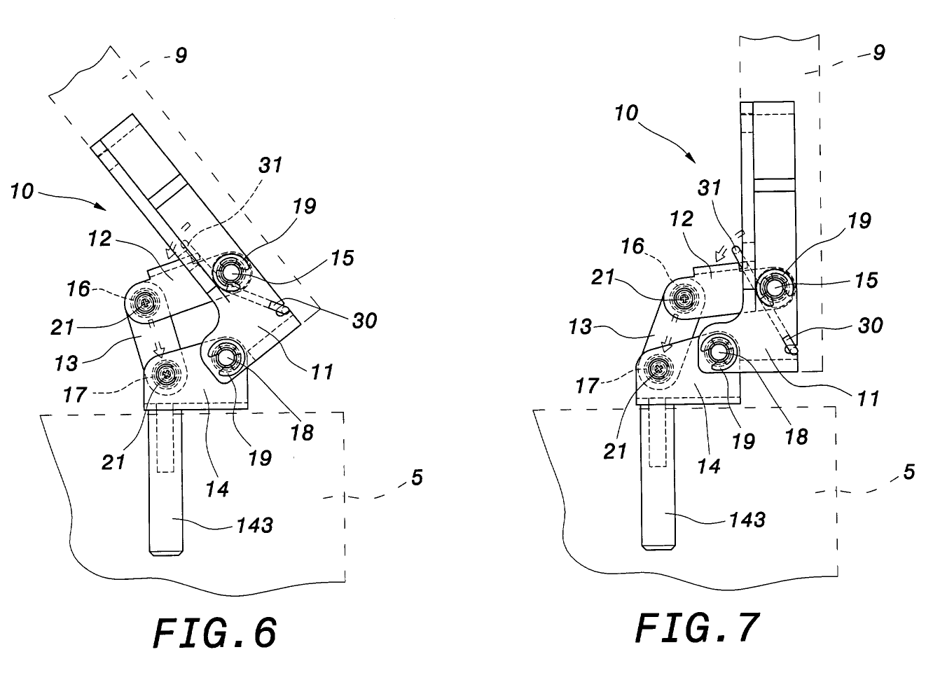

Referring to FIG. 3 to FIG. 5, the connecting rod mechanism 10 is composed of a first connecting rod 11, a second connecting rod 12, a third connecting rod 13, and base 14. The first connecting rod 11 consists of a side portion 111 and two extending side plates 112. Referring to FIG. 6, the lid 9 is fasten on the two extending side plates 112 of the first connecting rod 11 by screws or rivets. The second connecting rod 12 includes a top plate 121 comprising two second connecting rod side plates 122. The third connecting rod 13 is a solid body. The base 14 includes a bottom plate 141 comprising two base side plates 142. A vertical rod 143 is mounted at the bottom surface of the base plate 141. A plurality of pivot holes 20 are provided on each of the connecting rods. The side portion 111 of the first connecting rod 11 is connected with the second connecting rod side plates 122 by first pivot pin 15. A C-ring 19 is mounted on one end of the first pivot pin 15. The second connecting rod side plates 122 is connected with the third connecting rod 13 by second pivot pin 16. An adjusting screw 21 is screwed at one end of the second pivot pin 16. The adjusting screw 21 is used to force the second connecting rod side plates 122 to lean against adjacent side portions of the third connecting rod 13 and thus produce friction force. By screwing or loosing the adjusting screw 21 on the second pivot pin 16, the magnitude of the friction force can be changed. The base side plate 142 is connected with the third connecting rod 13 by third pivot pin 17. An adjusting screw 21 is screwed at one end of the third pivot pin 17. Likewise, the adjusting screw 21 is used to force the base side plate 142 to lean against adjacent side portions of the third connecting rod 13 and thus produce friction force. By screwing or loosing the adjusting screw 21 on the third pivot pin 17, the magnitude of the friction force can be changed. The side portion 111 of the first connecting rod 11 is connected with the base side plate 142 by fourth pivot pin 18. A C-ring 19 is mounted on one end of the fourth pivot pin 18 for fastening the first connecting rod 11 and the base 14 on the fourth pivot pin 18. In addition, the side portion 111 of the first connecting rod 11 has a recessed portion 113 and the top plate 121 of the second connecting rod 12 has a protruding portion 123. The spring 30 passed by the first pivot pin 15 may be a torsion spring. The spring 30 has a hook end 31 that leans against the top plate 121 of the second connecting rod 12 and hooks the protruding portion 123 of the top plate 121. The spring 30 has two spring arms 32 embedded in the recessed portion 113 of the first connecting rod 11 for providing the connecting rod mechanism 10 with torsion force.

Referring to FIG. 6 and FIG. 7, when the hinge device for copier lid as described above is applied on the copier machine 5, the lid 9 fixed on the first connecting rod 11 is opened at an angle of about 70 degree relative to the base 14 to facilitate a user to put paper documents on the glass of the copier machine 5. At this time, referring to FIG. 7, the lid 9 fixed on the first connecting rod 11 bumps up to a complete open status due to a countercurrent torsion exerted by the spring 30 that transmits from the second connecting rod 12, third connecting rod 13 to the base 14 so as to open the lid 9 to an equilibrium position. The torsion of the spring 30 overcomes the friction between the third connecting rod 13 and the first connecting rod 11 and between the third connecting rod 13 and the base 14.

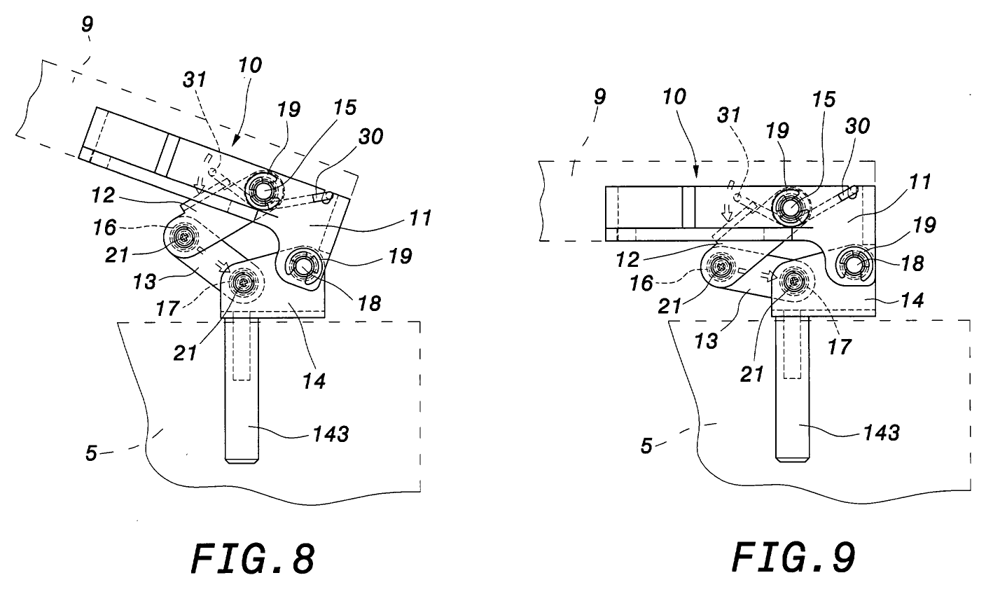

Referring to FIG. 8, when the lid 9 fixed on the first connecting rod 11 is opened at an angle of about 30˜70 degree relative to the base 14, the lid 9 fixed on the first connecting rod 11 can be in a stationary state at any angle. This is because that the friction force between the third connecting rod 13 and the first connecting rod 11 and between the third connecting rod 13 and the base 14, the gravity of the lid 9, and the torsion of the spring 30 are in an equilibrium state. Besides, the adjusting screws 21 on the third pivot pin 16 and fourth pivot pin 17 can be used to change the friction force between the connecting rods, so that the stationary angle of the lid 9 fixed on the first connecting rod 11 can be changed. When the lid 9 fixed on the first connecting rod 11 is at an angle of below 30 degree relative to the base 14, the lid 9 fixed on the first connecting rod 11 closes as illustrated in FIG. 9, to produce a downward force on the paper document (not shown). The parallel force of the torsion of the spring 30 exerts on the base 14. The vertical force of the torsion of the spring 30 supporting the lid 9 fixed on the first connecting rod 11 is insufficient to overcome the gravity of the lid 9 and the friction force between the third connecting rod 13 and the first connecting rod 11 and between the third connecting rod 13 and the base 14.

To sum up, the present invention provides an improved hinge device for copier lid. The improved device of this invention avoids friction loss between components of the prior art hinge device and reduces possibility of malfunction. Further, the hinge device according to the present invention occupies less space such that it is advantageous to apply the present invention on various machines. Moreover, the present invention is flexible and adjustable.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A hinge device for copier lid, comprising:
a connecting rod mechanism comprising a first connecting rod, a second connecting rod, a third connecting rod, and a base, the first connecting rod pivotally connected with the second connecting rod by a first pivot pin, the second connecting rod pivotally connected with the third connecting rod by a second pivot pin, the base pivotally connected with the third connecting rod by a third pivot pin, the first connecting rod pivotally connected with the base by a fourth pivot pin; and
a flexible device connected to the first connecting rod and penetratably connected by the first pivot pin, and the flexible device abutting upon the second connecting rod for transferring a spring force of the flexible device from the second connecting rod to the base, thereby rendering the copier lid close, open or static.

2. The hinge device for copier lid as claimed in claim 1 wherein a vertical rod is mounted at a bottom surface of the base.

3. The hinge device for copier lid as claimed in claim 1 further comprising a plurality of C-ring buckled on the first pivot pin and the fourth pivot pin.

4. The hinge device for copier lid as claimed in claim 3 further comprising:
a plurality of recessed portions disposed on side portions of the first connecting rod;
at least one protruding portion disposed on a top plate of the second connecting rod;
at least one hook portion and a plurality of spring arms disposed on the flexible device, said spring arms respectively being embedded in said recessed portions, and said hook portion abutting upon the second connecting rod and hooking the protruding portion for providing a torsion force for the connecting rod mechanism.

5. The hinge device for copier lid as claimed in claim 1 further comprising:
a plurality of second connecting side plate extending from two sides of the second connecting rod, and the third connecting rod pivotally connected with the second connecting rod by the second pivot pin; and
at least one screw at the end of the second pivot pin for leaning the second connecting rod side plates against the third connecting rod to form a friction force therebetween, the friction force being adjusted by screwing or loosing the screw on the second pivot pin.

6. The hinge device for copier lid as claimed in claim 1 further comprising:
a plurality of base side plates extending from two sides of the base, and the third connecting rod pivotally connected with the base by the third pivot pin; and
at least one screw screwing at the end of the third pivot pin for leaning the third connecting rod against the base to form a friction force therebetween, the friction force being adjusted by screwing or loosing the screw on the second pivot pin.

7. The hinge device for copier lid as claimed in claim 1 wherein the flexible device is a torsion spring.
